(19) United States
(12) Patent Application Publication
(10) Pub. No.: US 2004/0007312 A1
(43) Pub. Date: Jan. 15, 2004

(54) Mounting method

(76) Inventor: Akira Yamauchi, Shiga (JP)

Correspondence Address: SMITH PATENT OFFICE, 1901 PENNSYLVANIA AVENUE N W, SUITE 200, WASHINGTON, DC, 20006

(21) Appl. No.: 10/333,918

(22) PCT Filed: Jul. 30, 2001
(86) PCT No.: PCT/JP01/06552

(30) Foreign Application Priority Data
Aug. 4, 2000 (JP) 2000-237487

(51) Int. Cl. B32B 31/00

(52) U.S. Cl. 156/150; 156/250; 156/272.2

(57) ABSTRACT

Provided is a mounting method for bonding objects each having an electrode to each other by irradiating an energy wave or energy particle beam to an electrode of at least one of the objects to clean it, applying a nonconductive paste on the electrode while maintaining a special gas atmosphere, and bonding the electrode to an electrode of the other object fluxlessly with the nonconductive paste surface interposed therebetween. The primary and secondary oxidations of the electrodes of the objects are effectively prevented, thereby enabling fluxless bonding. The mounting steps are simplified and the quality of the bonded objects is improved.

### TECHNICAL FIELD OF THE INVENTION

The present invention relates to a mounting method for bonding objects each having an electrode to each other.

### BACKGROUND ART OF THE INVENTION

A mounting method for bonding objects each having an electrode to each other, for example, a method for bonding a chip formed with bumps as electrodes to a substrate by, for example, heating, is well known. As a typical process, a process is known wherein an electrode is cleaned prior to bonding, and after cleaning, a nonconductive paste is applied to ensure the sealability of a bonding portion after bonding and a flux is applied before bonding in order to ensure a good bonding and prevent the oxidation of the electrode at the time of bonding.

In such a conventional process, however, if the time up to the application of nonconductive paste or flux after preventing the primary oxidation of the electrode of the object by cleaning the electrode is long, there is a possibility that the electrode of the object, for example, a solder bump, may be oxidized.

Further, although the secondary oxidation of the electrode may be prevented at a certain degree by applying flux before heat bonding, if flux is applied, it is necessary to remove the residue of the flux after bonding, thereby causing a problem that the process becomes complicated.

### DISCLOSURE OF THE INVENTION

Accordingly, a purpose of the present invention is to provide an efficient mounting method which can effectively prevent the primary and secondary oxidations of an electrode of a object to be bonded, and which enables fluxless bonding and can simplify the bonding process.

To achieve the above-described purpose, a mounting method according to the present invention for bonding objects each having an electrode to each other comprises the steps of cleaning an electrode of at least one of the objects by irradiating an energy wave or energy particle beam to the electrode, applying a nonconductive paste on the electrode while maintaining a special gas atmosphere, and bonding the electrode to an electrode of the other object fluxlessly with the surface of the nonconductive paste interposed therebetween. Where, the “special gas atmosphere” means an atmosphere of an inert gas or a gas which does not react with the electrode of the object (for example, nitrogen gas), or a gas which can remove an oxide by reducing or substituting the oxide.

In this mounting method, although the cleaning and the application of the nonconductive paste can be carried out at a same place, in order to carry out the respective steps in respective optimum atmospheres, it is preferred to perform the cleaning step in a cleaning chamber and the applying step in an application chamber connected to the cleaning chamber, respectively.

As the energy wave or energy particle beam, a plasma, an ion beam, an atomic beam, a radical beam, a laser, etc. can be used. In particular, use of a plasma is preferable from the viewpoint of cleaning effect and simplification of an apparatus.

Although it is possible to also clean the electrode of the other object by irradiating the energy wave or energy particle beam and to further apply the nonconductive paste after the cleaning, because essentially there occurs no problem with respect to the oxidation of the surface if the electrode of the other object is plated with gold in advance, the cleaning by the energy wave or energy particle beam and the application of the nonconductive paste according to the present invention may be carried out only for another object. Namely, in the present invention, it may be carried out to bond the electrodes of both objects which are applied with the nonconductive paste after the above-described cleaning, or it may be carried out to clean only the electrode of one of the objects and apply the nonconductive paste thereonto, to plate the electrode of the other object with gold in advance, and to bond the electrodes of both objects.

Although the method for applying the nonconductive paste is not particularly restricted, the application by printing is preferred from the viewpoint of achievement of uniform application at a uniform application thickness within a predetermined region. As the printing, for example, a screen printing method such as a method disclosed in JP-A-10-313015 can be applied (however, the screen printing method is not limited to the method disclosed in the publication). Especially, if a so-called vacuum printing, which is carried out in a reduced-pressure atmosphere of the special gas atmosphere, is applied, it becomes possible to prevent the generation of voids which are formed by air left on the bottom portions of the irregular surface formed on an object by electrodes (bumps). In this printing, it is preferred to apply the nonconductive paste so that a portion provided with a recognition mark is left. The recognition mark, which is left so as to be exposed, is served to positional alignment at the time of dicing (for example, cutting into chips) or at the time of bonding of wafers.

The nonconductive paste to be applied comprises a liquid nonconductive resin for sealing an electrode, it is at least semi-cured after application and before bonding, and it seals the electrode from the surrounding atmosphere from a time during bonding to a time after bonding. Further, as this nonconductive paste, a paste containing conductive particles can also be used. The conductive particles can increase the reliability of the electric connection by being interposed between electrodes when the electrodes are bonded to each other.

Further, in the mounting method according to the present invention, it is possible to clean a relatively large object, for example, a wafer, by the above-described energy wave or energy particle beam, to apply the nonconductive paste thereonto in a special gas atmosphere after the cleaning, to cut the wafer applied with the nonconductive paste into a plurality of chips, and to bond the chips to the other object, for example, a substrate. Namely, the present invention also provides a method wherein an object applied with the nonconductive paste is cut into small objects after the applied nonconductive paste is at least semi-cured, and the electrode of each small object is bonded to the electrode of the other object fluxlessly with the surface of the nonconductive paste interposed therebetween.

In the present invention, the term of “electrode” is used as a concept containing an electrode which is formed as a flat electrode at the same level as the surface of an object or at a slightly higher level, and a formation of a so-called bump which is formed so as to be protruded on the flat electrode or on the surface of an object. Therefore, the bonding of electrodes also is used as a concept containing the bonding of bumps and the bonding of a bump and a flat electrode. Further, as the bonding method, although typically a heat bonding by a heater and the like is employed, the method is not limited thereto, and an ultrasonic bonding utilizing an ultrasonic wave may be employed.

In such a mounting method according to the present invention, because the nonconductive paste is applied while maintaining a special gas atmosphere after the electrode is cleaned by the energy wave or energy particle beam, the electrode, which has been cleaned and prevented from primary oxidation, is left as it is and sealed from the surrounding atmosphere by the applied nonconductive paste. Therefore, the primary oxidation from the cleaning to the application of the paste is prevented efficiently.

Since the objects are bonded (for example, heat bonded) to each other in this condition, there is no chance for the electrode coated with the nonconductive paste after cleaning to come into contact with the surrounding atmosphere, thereby preventing the secondary oxidation thereof effectively. Moreover, by coating the surface of the electrode after cleaning with the nonconductive paste, not only the oxidation but also reaction with the metal surface except the oxidation and adhesion of undesired foreign materials and reacted materials (for example, adsorption of CO, etc.), that become obstruction in the following bonding step), can be prevented. Therefore, fluxless bonding becomes possible, and a series of steps up to the completion of the bonding may be remarkably simplified by the fluxless condition. Further, because the nonconductive paste has been already applied in the bonding process and flux application step and removal step of the residue are unnecessary, the time required for a series of steps may be greatly shortened and the tact time may be shortened. Furthermore, because the primary and secondary oxidations of the electrode of the object are both prevented effectively and adhesion of foreign materials and the like is prevented effectively, an excellent quality of the bonded product may be ensured.

Further, since the nonconductive paste is applied after cleaning and the primary oxidation of the electrode is prevented, it becomes unnecessary to consider the time reaching the bonding process. As a result, for example, storage at the state applied with the nonconductive paste becomes possible, and it becomes possible to give a buffer to a series of production steps as needed.

Furthermore, if the nonconductive paste is applied, for example, uniformly by printing, and after the applied nonconductive paste is at least semi-cured, the object is cut into small objects (for example, chips), it becomes possible to easily make desirable small objects having a state prevented from primary oxidation. Such a small object is bonded to the other object (for example, a substrate) at a condition prevented from secondary oxidation and at a fluxless condition similarly to that aforementioned. Thus, while the primary and secondary oxidations are prevented, an efficient bonding may be carried out in a simplified series of steps, depending upon the formation of the object.

### BRIEF EXPLANATION OF THE DRAWINGS

FIG. 1 is a schematic partial view of a mounting apparatus used in a mounting method according to an embodiment of the present invention.

FIG. 2 is a schematic side view of a chip made by cutting a wafer applied with a nonconductive paste shown in FIG. 1.

FIG. 3 is a schematic view of a bonding process portion of the mounting apparatus.

FIG. 4 is a schematic vertical sectional view showing the bonding step of objects.

### THE BEST MODE FOR CARRYING OUT THE INVENTION

Hereinafter, desirable embodiments of the present invention will be explained referring to figures.

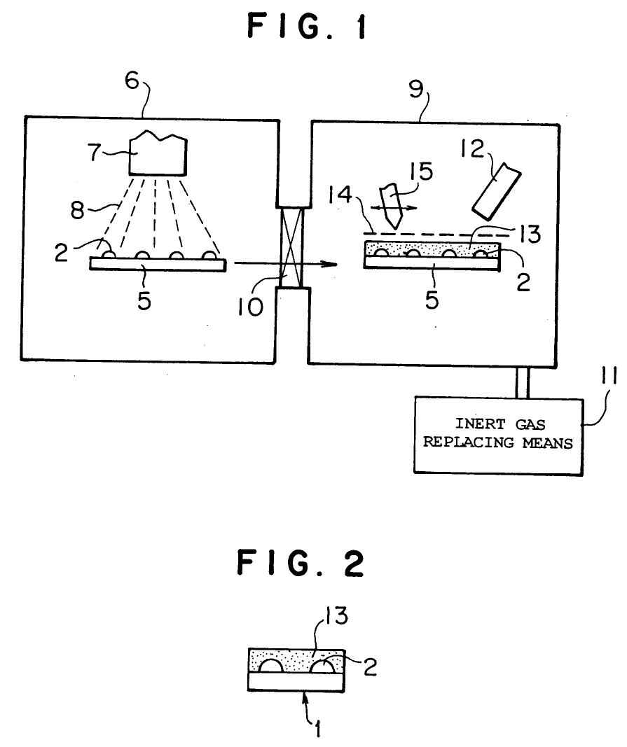

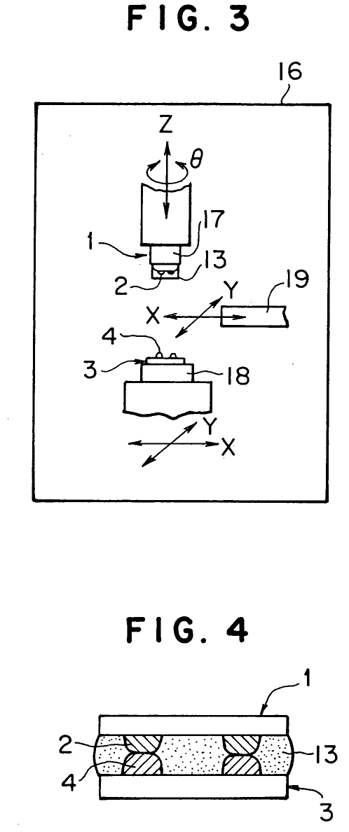

FIGS. 1 and 3 show a mounting apparatus used for carrying out a mounting method according to an embodiment of the present invention. In this embodiment, as shown in FIGS. 3 and 4, one of the objects to be bonded is a chip 1 with electrodes 2 and the other object is a substrate 3 with electrodes 4, and the electrodes 2 of the chip 1 and the electrodes 4 of the substrate 3 are heat bonded. However, the forms of these objects to be bonded to each other are not particularly restricted as long as they are adapted to the purpose of the present invention.

In this embodiment, each chip 1 is formed by cutting a wafer. As shown in FIG. 1, a wafer 5 with electrodes 2, which has a predetermined size, is introduced into a cleaning chamber 6, and the surfaces of the electrodes 2 are cleaned by irradiating an energy wave or energy particle beam 8 from cleaning means 7 toward the electrodes 2. In this embodiment, a plasma is used as the energy wave or energy particle beam 8. As the condition of the atmosphere in cleaning chamber 6 for generating the plasma, any of atmospheric-pressure and reduced-pressure conditions may be employed, and any of a special gas atmosphere such as an inert gas or a gas which does not react with electrodes 2, and an atmosphere of a gas which can remove an oxide by reducing or substituting the oxide, may be used.

Wafer 5 with cleaned electrodes 2 is transferred into an application chamber 9 connected to cleaning chamber 6. A gate 10 capable of sealing between both chambers 6 and 9 is provided therebetween, and it is possible to maintain the insides of the respective chambers 6 and 9 at gas atmospheres different from each other. In this embodiment, inert gas replacing means 11 is attached to application chamber 9 as special gas replacing means, and the inside of the application chamber 9 is converted into a predetermined inert gas atmosphere (for example, an argon gas atmosphere) when the application is carried out. By providing gate 10, the gas charge due to a pressure difference, such as one disclosed in JP-A11-233536, can be carried out. As the gas to be replaced by the special gas replacing means, not only the inert gas, but also a gas which does not react with the electrode (for example, nitrogen gas), or a reducing gas or a substituting gas capable of reducing or substituting an oxide on the surface of the electrode, can be used.

In application chamber 9, a nonconductive paste 13 discharged from application means 12 is applied onto the cleaned electrodes of wafer 5. The application is carried out, for example, by printing, and in this embodiment, a screen printing is performed using a screen 14 and a squeegee 15. At that time, as aforementioned, if a vacuum printing is applied, generation of voids is prevented. By such an application due to the printing, nonconductive paste 13 is applied uniformly over the entire range of a predetermined application region with a uniform thickness. Where, when recognition marks are provided on the edge portions of wafer 5, nonconductive paste 13 is not applied to the portions of the recognition marks for the positional alignment at the time of bonding described later.

Since the wafer 5, in which the oxide on the surface of electrodes 2 is removed by cleaning due to energy wave or energy particle beam 8 and the primary oxidation is prevented, is applied with nonconductive paste 13 in the special gas atmosphere as it is, the prevention of the primary oxidation of electrodes 2 is continued at the good condition by sealing due to the nonconductive paste 13.

In this condition, nonconductive paste 13 is at least semi-cured. Wafer 5 is turned in a condition capable of being cut by semi-curing nonconductive paste 13. In a case where wafer 5 is bonded as it is, the wafer 5 is sent to the bonding process after semi-curing of nonconductive paste 13, and in a case where small chips having a predetermined size are formed from wafer 5, the wafer 5 is cut. In this embodiment, wafer 5 is cut into each small chip 1 as shown in FIG. 2, after semi-curing of nonconductive paste 13.

The chip 1 thus formed is conveyed into a bonding chamber 16 as shown in FIG. 3. Further, a substrate 3 to be bonded with chip 1 is also introduced into bonding chamber 16. In this embodiment, electrodes 4 of substrate 3 are plated with gold in advance, and although there is a case where contamination is removed from these electrodes 4 of substrate 3 by plasma, essentially there occurs no problem on oxidation. Where, the “contamination” means organic substances, oxides and other foreign materials adhered to the electrodes of the substrate.

Chip 1 is held by a tool 17 at a turned-over condition, and substrate 3 is held by stage 18. In this embodiment, stage 18 can be adjusted in position in X and Y directions (horizontal direction), or in X and Y directions (horizontal direction) and rotational direction (θ direction). Tool 17 can be adjusted in position in Z direction (vertical direction), or in Z direction (vertical direction) and rotational direction (θ direction). In the present invention, these methods for positional adjustment are not particularly restricted. Further, in order to detect an amount of positional shift between upper and lower objects and adjust the positional relationship therebetween within a desirable accuracy range based on the detected amount, recognition means 19 for reading recognition marks provided on the upper and lower objects is provided so as to be proceeded and retreated between stage 18 and tool 17. As the recognition means 19, any means can be used regardless of kind and size as long as it can recognize the recognition marks such as a CCD camera, an infrared camera, an X-ray camera, a sensor, etc. This recognition means 19 can also be adjusted in position in X and Y directions (as needed, further in Z direction (vertical direction)). Further, this recognition means may be constructed as separate menas for reading the respective recognition marks provided on the upper and lower objects independently. The alignment may be carried out on any side of the tool side and the stage side, or may be carried out on both sides.

After the alignment, chip 1 and substrate 3 are heat bonded. In this heat bonding, as shown in FIG. 4, electrodes 2 of chip 1 (for example, electrodes formed as solder bumps) which are prevented from being oxidized by nonconductive paste 13, and electrodes 4 of substrate 3 which are plated with gold and have no fear of being oxidized, are bonded in nonconductive paste 13, especially the electrodes 2 of chip 1 are heated in the nonconductive paste 13, and therefore, the secondary oxidation due to heating can be prevented effectively. Further, because the paste resin semi-cured in a B-stage condition is cured after once being reduced in viscosity when being heated, the solder forming electrodes 2 is wetted when the viscosity reduces, a good soldering can be carried out, and there occurs no inconvenience at the time of handling.

Since the heat bonding is carried out at a condition where the primary and secondary oxidations are both prevented, for this heat bonding, basically it is not necessary to use flux, which has been used in a conventional method. Namely, fluxless bonding becomes possible. Because of fluxless condition, a flux application step and a flux residue removal step are unnecessary, a series of steps are remarkably simplified, and the tact time is shortened.

Since the bonding of chip 1 and substrate 3 is carried out at a condition where the primary and secondary oxidations are prevented, the quality after bonding is extremely excellent in spite of the simple series of steps.

Further, since a fear of the oxidation of electrodes 2 is removed by the sealing due to nonconductive paste 13, during the period of time from the cleaning and the application of the nonconductive paste to the bonding process, it is possible to leave the object as it is, and as needed, it is possible to provide a buffer storage for production. Further, because wafer 5 can be cut into small-size chips 1 during the time up to the bonding process, as needed as described above, while the cleaning and the application of nonconductive paste 13 are carried out efficiently for wafer 5 having a relatively large area, a desirable heat bonding of chip 1 and substrate 3 can be carried out in the bonding process, and the efficiency of the entire process with the series of steps can be improved.

In the present invention, the portions to be bonded include bonding portions of so-called substitute solders such as tin/silver or Bi/In, and bonding portions of gold/tin or gold/gold, except the usual bonding portions due to a solder of lead/tin. Further, the electrode in the present invention includes not only an electrode accompanying with an electric wire but also a dummy electrode to which no wire is connected. Further, in the present invention, the chip includes all objects being bonded to a substrate regardless of kind and size, such as an IC chip, a semiconductor chip, an optoelectronic element, surface mounting parts, and a wafer. The substrate in the present invention includes all objects being bonded to a chip regardless of kind and size, such as a resin substrate, a glass substrate, a film substrate, a chip, and a wafer. The present invention is effective not only for solder bumps but also all kinds of electrodes reacting as primary oxidation and/or secondary oxidation.

### INDUSTRIAL APPLICATIONS OF THE INVENTION

The mounting method according to the present invention can be applied to any mounting for bonding objects each having an electrode. By application of the present invention, a series of steps can be simplified and the quality of the bonded objects is improved.

1. A mounting method for bonding objects each having an electrode to each other comprising the steps of:
cleaning an electrode of at least one of said objects by irradiating an energy wave or energy particle beam to said electrode;
applying a nonconductive paste on said electrode while maintaining a special gas atmosphere; and
bonding said electrode to an electrode of the other object fluxlessly with the surface of said nonconductive paste interposed therebetween.

2. The mounting method according to claim 1, wherein said cleaning is carried out in a cleaning chamber and said applying is carried out in an application chamber connected to said cleaning chamber, respectively.

3. The mounting method according to claim 1, wherein a plasma is used as said energy wave or energy particle beam.

4. The mounting method according to claim 1, wherein said electrode of the other object is plated with gold.

5. The mounting method according to claim 1, wherein said applying is carried out by printing.

6. The mounting method according to claim 5, wherein said printing is carried out by vacuum printing.

7. The mounting method according to claim 1, wherein said nonconductive paste is applied on one of said objects within a region except a portion provided with a recognition mark.

8. The mounting method according to claim 1, wherein a paste containing conductive particles is used as said nonconductive paste.

9. The mounting method according to claim 1, wherein an object applied with said nonconductive paste is cut into small objects after said applied nonconductive paste is at least semi-cured, and the electrode of each small object is bonded to said electrode of the other object fluxlessly with the surface of said nonconductive paste interposed therebetween.
